(19) United States
(12) Patent Application Publication
(10) Pub. No.: US 2014/0025257 A1
(43) Pub. Date: Jan. 23, 2014

(54) Drive Assist Apparatus Assisting Driver To Drive Vehicle Based On Degree Of Fatigue Of Driver

(71) Applicant: Denso Corporation, Kariya-city (JP)

(72) Inventor: Yuuta Komoguchi, Kariya-shi (JP)

(73) Assignee: Denso Corporation, Kariya-city (JP)

(21) Appl. No.: 13/947,240

(22) Filed: Jul. 22, 2013

(30) Foreign Application Priority Data
Jul. 23, 2012 (JP) 2012-162800

(51) Int. Cl. B60Q 5/00

(52) U.S. Cl. CPC B60Q 5/005
USPC 701/36; 701/1

(57) ABSTRACT

A drive assist apparatus that assists the driver of the vehicle to appropriately drive the vehicle includes: a detecting unit, a drive assist unit, a fatigue calculating unit and a setting unit.

The detecting unit detects a positional relationship between the vehicle and the traffic lane, and the drive assist unit performs a drive assist process that suppresses the vehicle departing from the traffic lane, based on the positional relationship. Moreover, the fatigue calculating unit calculates a degree of fatigue of the driver and the setting unit sets a mode of the drive assist process in response to the degree of fatigue calculated by the fatigue calculating unit.

### CROSS REFERENCE TO RELATED APPLICATION

This application is based on and claims the benefit of priority from earlier Japanese Patent Application No. 2012-162800 filed on Jul. 23, 2012 the description of which is incorporated herein by reference.

### BACKGROUND

1. Technical Field

The present disclosure relates generally to a driving assist apparatus that assists driving a vehicle. More particularly, the present disclosure relates to a driving assist apparatus capable of assisting drive operation to prevent lane departure of the vehicle.

2. Description of the Related Art

Conventionally, an apparatus mounted on a vehicle used to recognize a traffic lane has been developed. For example, Japanese Patent Application Laid-Open Publication No. 2010-173367 discloses an on-vehicle apparatus used to recognize a traffic lane. Specifically, the apparatus includes an on-vehicle camera that takes an image of the traffic lane and performs an image processing about the image of the traffic lane so as to recognize a boundary of the traffic lane. This type of apparatus can perform a drive assist that generates an alert sound to notify the driver when the vehicle is likely to depart from the traffic lane.

However, according to the apparatus of the above-described patent document, the drive assist is performed based on only a positional relationship between the vehicle and the traffic lane, and fatigue of the driver is not considered when performing the drive assist. Therefore, a mode of the drive assist cannot be changed depending on fatigue of the driver. Meanwhile, assuming the apparatus employs an alert sound in order to suppress a lane departure of the vehicle, if the driver is suffering from fatigue, a different alert sound capable of easily notifying the driver is preferably employed when comparing the driver does not suffer from the fatigue.

### SUMMARY

The embodiment provides a drive assist apparatus capable of executing an appropriate drive assist processing adapted to suppress a lane departure of the vehicle based on degree of fatigue of the driver.

Specifically, according to the drive assist apparatus of the present disclosure, detecting means detects a positional relationship between the vehicle and the traffic lane and the drive assist means performs a drive assist process that suppresses the vehicle departing from the traffic lane, based on the positional relationship. Moreover, fatigue calculating means calculates a degree of fatigue of the driver and the setting means sets a mode of the drive assist process in response to the degree of fatigue calculated by the fatigue calculating means.

According to the drive assist apparatus of the present disclosure, an appropriate mode of operation can be determined by the setting means in response to the degree of the fatigue of the driver of the vehicle, and the drive assist means can perform the drive assist based on the degree of fatigue.

### BRIEF DESCRIPTION OF THE DRAWINGS

In the accompanying drawings:

FIG. 1 is a block diagram showing a drive assist apparatus of the present disclosure;

FIG. 2 is a flowchart showing a processing in the first embodiment executed by the drive assist apparatus;

FIGS. 3A and 3B are explanatory diagrams showing a calculation method of a zigzag driving of the vehicle in the processing according to the first embodiment;

FIG. 4 is a graph showing a specific example of the calculation method of the zigzag driving of the vehicle;

FIG. 5 is a diagram that explains a definition table for setting a sound and a volume related to the specific example of the calculation method;

FIG. 6 is a flowchart showing a processing in the second embodiment executed by the drive assist apparatus; and

FIG. 7 is an explanatory diagram showing a fatigue judgment interval according to other embodiment.

### DETAILED DESCRIPTION OF THE PREFERRED EMBODIMENTS

### First Embodiment

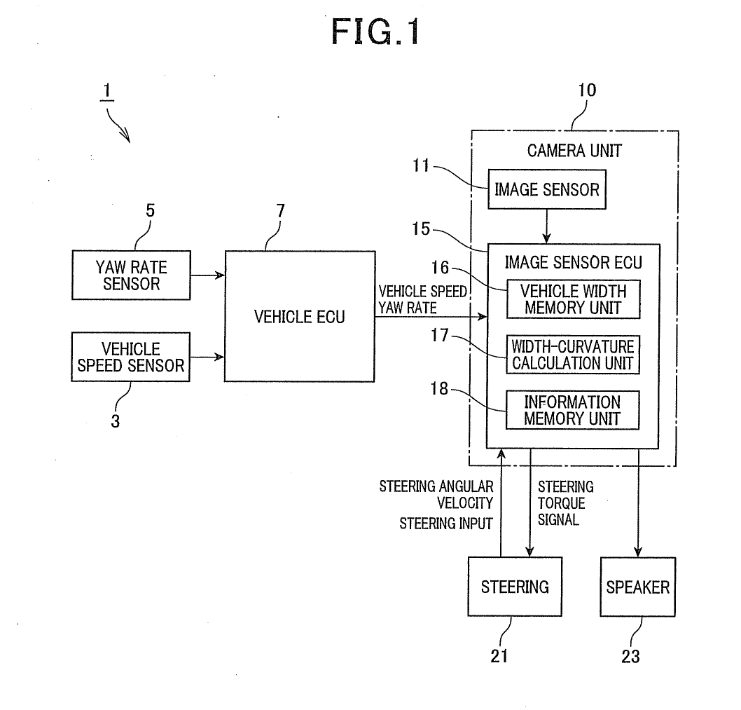

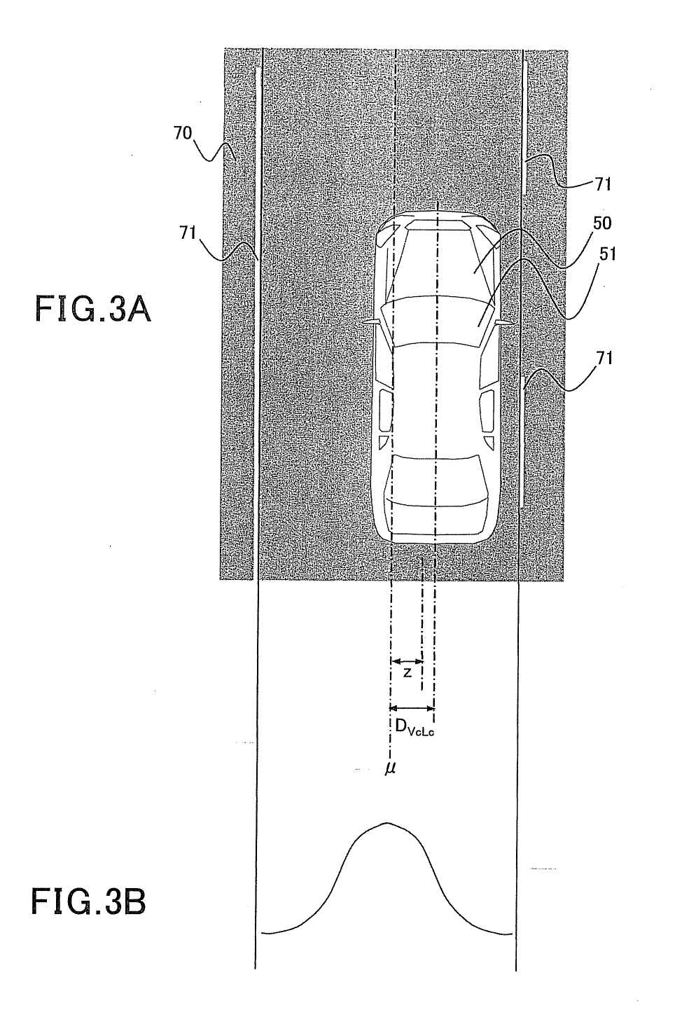

Next, with reference to the drawings, the overall configuration according to the embodiments of the present disclosure is described as follows. A drive assist apparatus 1 according to the first embodiment is mounted on a vehicle 50 (FIG. 3A). As shown in FIG. 1, the drive assist apparatus 1 is provided with a vehicle ECU (electronic control unit) 7 including a vehicle speed sensor 3 and a yaw rate sensor 5 connected thereto, and a camera unit 10 connected to the vehicle ECU 7. The camera unit 10 includes an image sensor 11 comprising image devices such as CCD (charge coupled device) and an image sensor ECU 15. The camera unit 10 is attached to a rear-view mirror (not shown) disposed at an upper-center portion of a front windshield 51 of the vehicle 50 (FIG. 3A). In more detail, the camera unit 10 is attached to a vicinity of a base portion of the rear-view mirror in the backside thereof.

The image sensor 11 is adapted to acquire image ahead of the vehicle 50 through the windshield 51 and process the acquired images to recognize a white line 71 on the road 70 (FIG. 3A). Since the processing to recognize the white line 71 is well known technique, detail explanation thereof is omitted.

As shown in FIG. 1, the image sensor EU 15 includes a vehicle width memory unit 16, a width-curvature calculation unit 17, an information memory unit 18. The vehicle width memory unit 16 is constituted by a ROM (read only memory) and stores a width of the vehicle 50 on which the camera unit 10 is mounted. The width-curvature calculation unit 17 calculates the width of a lane (i.e., traffic lane) on which the vehicle 50 is running, and the curvature R of the traffic lane based on an arrangement of the marker on the road such as the white line 71 recognized by the image sensor ECU 15. Further, the information memory unit stores the number of lane departures where the vehicle 50 departed from the traffic lane defined by the right and left while lines 71 and other events related to running state of the vehicle 50 (described later). The information memory unit stores the number of lane departures and other events occurred within a predetermined period (e.g. n minutes).

Furthermore, a steering 21 and a speaker 23 are connected to the image sensor ECU 15. The steering 21 includes EPS (Electric Power Steering) and adapted to assist steering operation of the driver in response to signals transmitted from the image sensor ECU 15. Also, the steering 21 outputs a state of operation of the steering wheel (not shown) by the driver to the image sensor ECU 15. Specifically, the steering 21 outputs a signal representing an angular velocity when the steering wheel is operated and the image sensor ECU 15 receives the signal outputted by the steering 21 as a steering angular velocity. Moreover, the image sensor ECU 15 receives a steering input that represents whether or not power is applied to the steering wheel. The image sensor ECU 15 is capable of outputting a control signal to avoid a lane departure of the vehicle 50. The steering 21 can receive the control signal as a steering torque signal from the image sensor ECU 15. The image sensor ECU 15 receives signals from the vehicle ECU 7, which represents a running speed of the vehicle 50 detected by the vehicle speed sensor 3 and a yaw rate (i.e., angular velocity in turning direction of the vehicle) detected by the yaw rate sensor 5

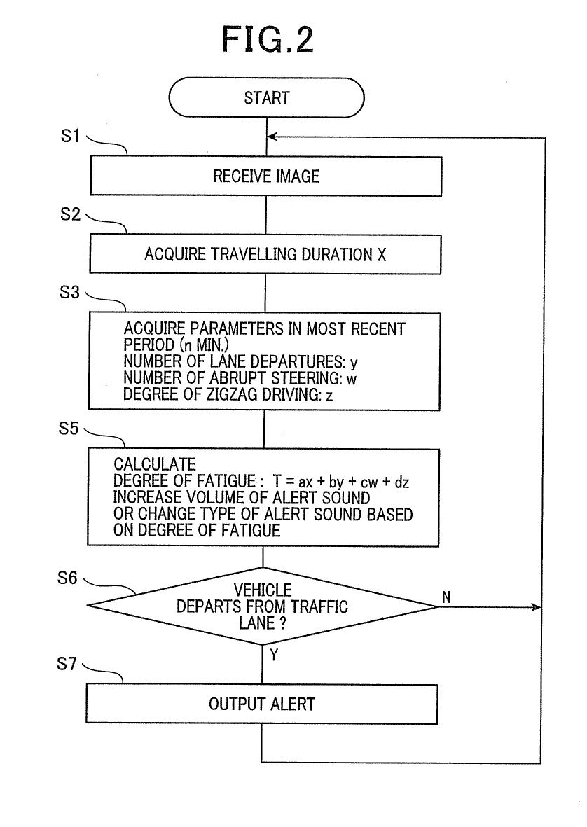

Next, an example of a process executed by the drive assist apparatus 1 (i.e., drive assist process) according to the first embodiment is now described with reference to the flowchart as shown in FIG. 2. When the drive assist apparatus 1 executes the processing to prevent the vehicle 50 departing from the traffic lane, the image sensor ECU 15 may output the steering torque signal to the steering 21 as described above so as to assist the driving operation of the driver, however, according to the first embodiment, the drive assist apparatus 1 employs only an alert notification by using the speaker 23.

As shown in FIG. 2, at S1 (S represents steps: the same applies hereinafter), the drive assist apparatus 1 receives the image acquired by the image sensor 11. Then, the white line 71 is recognized by another process (not shown). Subsequently, at step 2, the process acquires a travelling duration x of the vehicle 50 since the ignition turned ON (e.g. accumulated travelling time when the vehicle 50 travels at 5 km/hour). The travelling duration is acquired from the vehicle ECU 7. At S3, parameters including the number of lane departures y, the number of abrupt steering w and degree of zigzag driving z, which have been occurred within a period of most recent n minutes are acquired. It is noted that the number of line departures y are the number of counts where the vehicle 50 departed from the white line 71. The number of abrupt steering w is the number of counts where the steering angle velocity exceeds a predetermined angular velocity. The degree of zigzag driving z is calculated by using a standard deviation of a variation of the center axis in the longitudinal direction of the vehicle 50 with respect to the center of the road 70, which is described as follows.

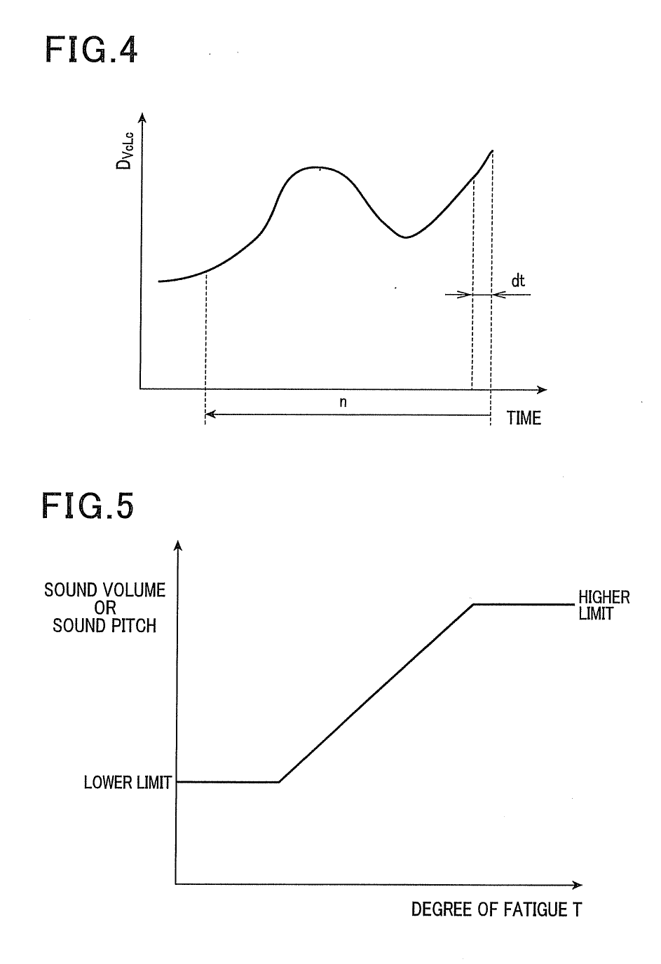

That is, as shown in FIG. 3A, assuming the center of the road 70 is μ, the center axis of the vehicle 50 shows a distribution as shown in FIG. 3B. Hence, when a deviation of the center axis in the longitudinal direction of the vehicle 50 with respect to the center of the road 70 μ is D_{VcLc}, the deviation D_{VcLc} varies with respect to the time as shown in FIG. 4. Assuming the period of n minutes is divided into a predetermined calculation period dt, e.g. 1 min, and the deviation D_{VcLc} at each predetermined calculation period dt is D_{VcLc} i (0≦i≦n), the degree of zigzag driving z expressed by standard deviation is calculated as the following equation.

$$Z = \sqrt{{\sum }_{i = 0}^{n} {( {D}_{VcLc} i )}^{2}}$$

Next at S5, a degree of fatigue T is calculated based on the parameters x, y, w and z acquired at S2 and S3 as follows.

Then, the drive assist apparatus 1 executes a process that determines based on the degree of fatigue T, whether or not a volume of an alert sound should be increased or type of alert sound should be changed. It is noted that the volume of alert sound is increased proportionately to the degree of fatigue T or changes type of alert sound. In other words, at S5, the degree of fatigue T is calculated first with the equation, T=ax+by+cw+dz.

The parameters a to d are coefficients used for normalizing/weighting the degree of fatigue T to be within a range, e.g. from the minimum value 0 to the maximum value 1. The parameter b is weighted so as to reduce influence of the parameter y, when the line departure is likely occur (e.g. vehicle having wider width, narrower lane width at an ordinary road and large curvature of the road). For example, the parameter b can be set to a value to be inversely-proportional to the width of the vehicle acquired from the vehicle width memory unit 16, or can be set to a value to be proportional to the width of the lane or the curvature R which are acquired by the width-curvature calculation unit 17, or can be set to a value of the any combination of these values. Further, the parameter b can be set to 0 while the running speed of the vehicle has been less than predetermined speed v km/hour (e.g. 5 km/hour) for n minutes.

The parameter d is weighted to reduce influence of the parameter z when it is difficult to keep the vehicle 50 to be on the center of the road 70. For example, the vehicle 50 is running on an ordinary road where the width of the road is likely to change so that the vehicle 50 tends to run zigzag or the driver drives the vehicle 50 towards the center of the curved road when the vehicle 50 is running on a winding road. The parameter d can be set to a value proportional to the curvature R of the road or can be set to 0 when stop-and-go driving occurs more than m times within n minute or the running speed of the vehicle 50 has been below v km/hour (e.g. 5 km/hour) for n minutes. Moreover, when it is possible to acquire intensity of crosswind, the parameter d can be set such that the stronger the intensity of the crosswind, the smaller the parameter d.

Next at S5, calculating the degree of fatigue as described above, the volume of the alert sound (sound volume) is set based on a definition table as shown in FIG. 5. As shown in FIG. 5, the definition table is configured such that the sound volume increases to be proportional to the degree of fatigue T within a volume range between the lower limit and the upper limit. At S5, after calculating the degree of fatigue based on the above-described equation, the sound volume is calculated based on the definition table. It is noted that pitch of the alert sound (sound pitch) can be set by using the same definition table at S5. For example, assuming the upper limit frequency of the alert sound can easily be recognized by the driver, FIG. 5 can be changed such that the vertical axis of the table is replaced to the frequency of the alert sound. Also, in response to the degree of fatigue, type of alert sound can be changed to any one of sounds among a predetermined several types of sounds.

Subsequently at S6, the process determines whether or not the vehicle 50 has departed from the traffic lane (i.e., lane departure) and returns to S1 when the vehicle has not departed from the traffic lane (S6: No). Meanwhile, when it is determined that the vehicle 50 has departed from the traffic lane (S6: YES), the process generates an alert sound with a predetermined sound volume which is set at S5 and outputs the alert sound. Then, the process proceeds to S1. At S6, likewise a well-known Lane Departure Warning (LDW), the process may determine the lane departure when a probability of the lane departure exceeds a predetermined value as well as the vehicle 50 actually departs from the traffic lane.

Thus, according to the first embodiment, when the degree of fatigue of the driver is relatively high, an appropriate drive assist depending on the degree of fatigue of the driver can be performed. That is, the drive assist apparatus 1 generates/outputs a different alert sound capable of easily notifying the driver when comparing the fatigue of the driver is low. In the first embodiment, the number of lane departures y, the number of abrupt steering w and degree of zigzag driving z are acquired from predetermined period, (i.e., most recent n min. period). Therefore, the drive assist apparatus 1 is able to alert the driver depending on the degree of fatigue, and a state of alert can be reset when the fatigue of the driver is recovered.

### Second Embodiment

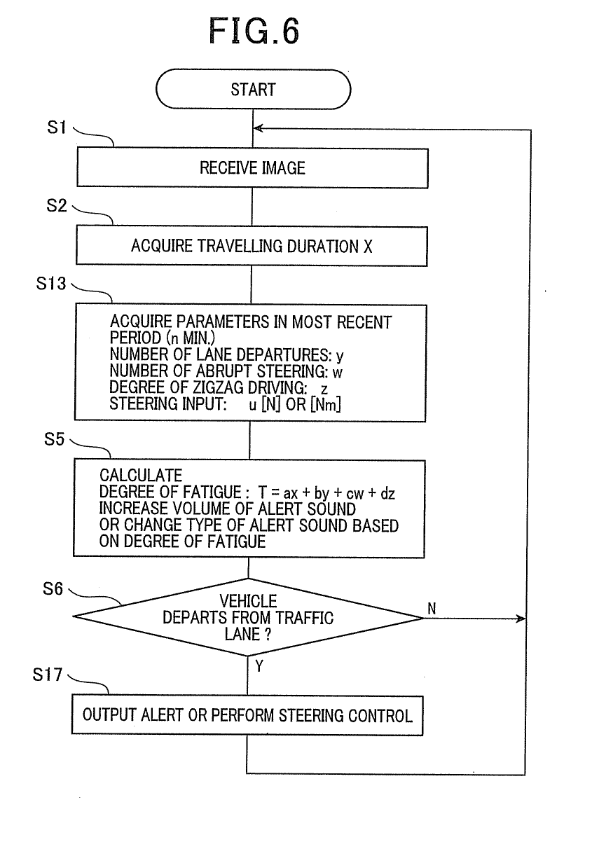

Next, an example of a process executed by the drive assist apparatus 1 (i.e., drive assist process) according to the second embodiment is now described with reference to the flowchart as shown in FIG. 6. In the process, the image sensor ECU 15 outputs the steering torque signal to the steering 21 so as to assist the driving operation of the driver. According to the second embodiment, since processes at S13 and S17 are executed instead of the processes at S3 and S7 of the first embodiment and other processes are identical to the first embodiment, only the differences between the first embodiment and the second embodiment is described as follows.

As shown in FIG. 6, at S13, the process acquires a steering input u which has been received by the steering for the last n minutes, in addition to the number of lane departures y, the number of abrupt steering w and degree of zigzag driving z. That is, based on the steering input outputted by the steering 21, the process acquires power applied to the steering wheel by the driver [N] or torque [Nm]. Subsequently at S5, the degree of fatigue T is calculated based on the equation, T=ax+by+cw+dz and the sound volume or the pitch of the sound is set in response to the degree of fatigue T.

When the sound volume or the pitch of the sound is set at S5, next at S6, as similar to the well-known technique, Lane Departure Prevention (LDP), the process determines whether or not a lane departure has been occurred. The process proceeds to S17 when the lane departure is determined (S6: YES). At S17, the speaker 23 outputs alert sound as similar to that in S7 and the image sensor ECU 15 outputs the steering torque signal to the steering 21 so as to execute a steering control thereby suppressing the lane departure. Then, the process returns to the above-described S1.

In this process, as similar to that of the first embodiment, the alert sound can be generated depending on the degree of fatigue T. According to the second embodiment, only the alert sound is changed depending on the degree of fatigue T, however, the steering control at S17 may be performed only when the degree of fatigue T is larger than a predetermined value.

According to the above-described embodiments, the image sensor 11 and the image sensor ECU 15 correspond to detecting means, the image sensor ECU 15, the steering 21, the speaker 23 correspond to drive assist means, the image sensor 11, the image sensor ECU 15 and the steering 21 correspond to information acquiring means. Moreover, the process of S1 among processes executed by the image sensor ECU 15 corresponds to detecting means. Similarly, processes of S7 and S17 correspond to drive assist means, processes of S2, S3 and S13 correspond to information acquiring means, the process for calculating the degree of fatigue among processes of S5 correspond to fatigue calculating means, the process for setting the sound volume and the pitch of the sound among processes of S5 correspond to setting means.

The present disclosure is not limited to the above-described embodiments, however, various modifications can be made within a scope of the present disclosure. For example, depending on the drivers, even they do not suffer from fatigue, some driver drives the vehicle tending to the right side of the traffic lane, and other drivers drives the vehicle tending to the left side of the traffic lane. Hence, the number of line departures y is defined to be divided into the number of line departures towards right side yr and the number of line departures towards left side yl. Then, the degree of fatigue T is calculated to be weighted for both number of line departures yr and yl. Also, the degree of lane departure is multiplied by each of the number of line departures yr and yl so as to obtain total amount of lane departure.

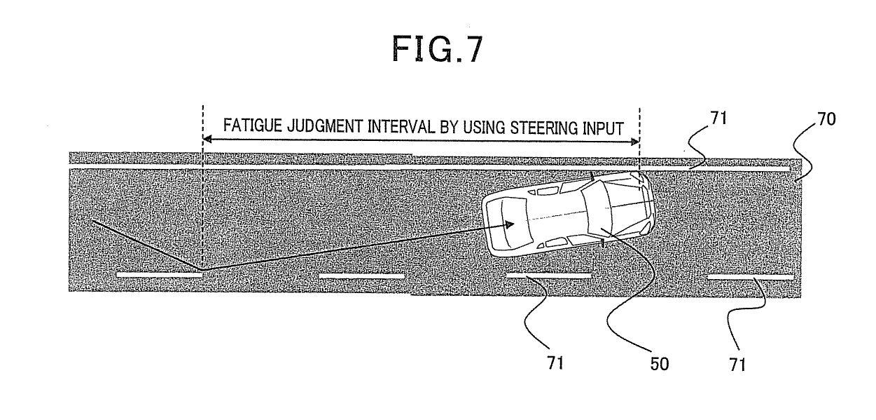

When the degree of fatigue of the driver is large, it is likely to occur that the driver does not apply force to the steering wheel while the vehicle 50 travels from the one edge (right side or left side) to the other edge (left side or right side) of the traffic lane. As shown in FIG. 7, the process determines whether or not the image sensor ECU 15 receives a steering input u while the vehicle 50 travels from one side of the white line 71 (right side) to the other side of the white line 71 (left side) so as to calculate the degree of fatigue (i.e., fatigue judgment interval). Further, the degree of fatigue T is not limited to three or more numbers, however, two values of information can be used for the degree of fatigue T. For example, the degree of fatigue is expressed as 1: fatigue exists, 0: no fatigue exists. In this case, the process may determine that fatigue exists when the travelling duration x exceeds a predetermined period or when lane departure has been occurred at least once or abrupt steering has been occurred at least once. When the process determines that fatigue exists, the sound volume may be increased gradually every time when the fatigue is determined.

### Other Embodiments

The embodiments as described above can be modified as follows.

The present disclosure may further include information acquiring means for acquiring two or more information including the number of lane departure of the vehicle within most recent first predetermined period, the number of times that the steering angle exceeds a predetermined angular velocity within most recent second predetermined period and the number of zigzag driving of the vehicle within most recent third predetermined period, while the vehicle continues to travelling. When the fatigue calculating means calculates the degree of fatigue based on the two or more information, following effects and advantages can be obtained.

It is considered that the degree of fatigue can be calculated by using other methods such that the expression of the driver is captured by a camera and analyzed so as to calculate the degree of fatigue. However, according to the above-described acquiring means used for calculating the degree of fatigue, sensor devices in the vehicle used for controlling the Lane Departure Prevention or the Lane Departure Warning can be employed without any modifications to calculate the degree of fatigue. In this instance, the first predetermined period, the second predetermined period and the third predetermined period can be the same value or can be different values each other.

The information acquiring means can be configured to acquire, as numeric information, the number of lane departure of the vehicle within most recent first predetermined period, the number of times that the steering angle exceeds a predetermined angular velocity within most recent second predetermined period and the number of zigzag driving of the vehicle within most recent third predetermined period, while the vehicle continues to travelling. The fatigue calculating means can be configured to calculate the degree of fatigue based on the numeric information such that the respective numeric information is multiplied by coefficients of which values are individually set based on the vehicle and the traffic lane where the vehicle runs and the sum of the respective numeric information is obtained to calculate the degree of fatigue. In this instance, the degree of fatigue can be calculated accurately and divided into large number of steps by using the numeric information.

Moreover, the drive assist means may execute an drive assist process that generates and outputs an alert sound when the vehicle departs from the traffic lane or probability of the lane departure of the vehicle is larger than a predetermined value and, the setting means may set a state of the alert sound depending on the degree of fatigue calculated by the fatigue calculating means. In this case, as described above, when the degree of fatigue of the driver is high, an alert sound capable of notifying the driver more easily compared to an alert sound when the degree of fatigue of the driver is low can be generated and outputted. As a result, appropriate drive assist depending on the degree of fatigue can be performed.

What is claimed is:

1. A drive assist apparatus mounted on a vehicle, assisting a driver driving the vehicle comprising:
detecting means for detecting a positional relationship between the vehicle and a traffic lane where the vehicle runs;
drive assist means for performing a drive assist process based on the positional relationship detected by the detecting means, wherein the drive assist process suppresses the vehicle departing from the traffic lane;
fatigue calculating means for calculating a degree of fatigue of the driver; and
setting means for setting a mode of the drive assist process in response to the degree of fatigue calculated by the fatigue calculating means;

2. The drive assist apparatus according to claim 1 further includes information acquiring means for acquiring two or more information including a number of lane departure of the vehicle within a most recent first predetermined period, a number of times that a steering angle exceeds a predetermined angular velocity within most recent second predetermined period and a number of zigzag driving of the vehicle within most recent third predetermined period, while the vehicle continues to travel,
wherein the fatigue calculating means is configured to calculate the degree of fatigue based on the two or more information acquired by the information acquiring means.

3. The drive assist apparatus according to claim 2, wherein the information acquiring means is configured to acquire, as numeric information, the number of lane departure of the vehicle within the most recent first predetermined period, the number of times that the steering angle exceeds a predetermined angular velocity within the most recent second predetermined period and the number of zigzag driving of the vehicle within the most recent third predetermined period, while the vehicle continues to travel,
and the fatigue calculating means is configured to calculate the degree of fatigue based on the numeric information such that respective numeric information is multiplied by coefficients of which values are individually set based on the vehicle and the traffic lane where the vehicle runs and a sum of the respective numeric information is obtained to calculate the degree of fatigue.

4. The drive assist apparatus according to claim 1, wherein the drive assist means is configured to execute the drive assist process that generates and outputs an alert sound when the vehicle departs from the traffic lane or probability of the lane departure of the vehicle is larger than a predetermined value and,
the setting means is configured to set a state of the alert sound depending on the degree of fatigue calculated by the fatigue calculating means.

5. The drive assist apparatus according to claim 2, wherein the drive assist means is configured to execute the drive assist process that generates and outputs an alert sound when the vehicle departs from the traffic lane or probability of the lane departure of the vehicle is larger than a predetermined value and,
the setting means is configured to set a state of the alert sound depending on the degree of fatigue calculated by the fatigue calculating means.

6. The drive assist apparatus according to claim 3, wherein the drive assist means is configured to execute the drive assist process that generates and outputs an alert sound when the vehicle departs from the traffic lane or probability of the lane departure of the vehicle is larger than a predetermined value and,
the setting means is configured to set a state of the alert sound depending on the degree of fatigue calculated by the fatigue calculating means.
